(19) United States
(12) Patent Application Publication
(10) Pub. No.: US 2015/0125052 A1
(43) Pub. Date: May 7, 2015

(54) DRUSEN LESION IMAGE DETECTION SYSTEM

(71) Applicants: AGENCY FOR SCIENCE, TECHNOLOGY AND RESEARCH, Singapore (SG); SINGAPORE HEALTH SERVICES PTE LTD, Singapre (SG)

(72) Inventors: Wing Kee Damon Wong, Singapore (SG); Xiangang Cheng, Singapore (SG); Jiang Liu, Singapore (SG); Ngan Meng Tan, Singapore (SG); Beng Hai Lee, Singapore (SG); Fengshou Yin, Singapore (SG); Mayuri Bhargava, Singapore (SG); Gemmy Cheung, Singapore (SG); Tien Yin Wong, Singapore (SG)

(21) Appl. No.: 14/406,201

(22) PCT Filed: Jun. 5, 2013
(86) PCT No.: PCT/SG2013/000235

§ 371 Date: Dec. 5, 2014

(30) Foreign Application Priority Data
Jun. 5, 2012 (SG) 201204125-7

(51) Int. Cl. G06T 7/00; G06T 7/40; G06K 9/00; G06K 9/46

(52) U.S. Cl. CPC G06T 7/0012; G06K 9/46; G06T 7/408; G06T 7/40; G06K 9/00597; G06K 2009/4666
USPC 382/128

(57) ABSTRACT

A method is proposed for automatically analysing a retina image, to identify the presence of drusen which is indicative of age-related macular degeneration. The method proposes dividing a region of interest including the macula centre into patches, obtaining a local descriptor of each of the patches, reducing the dimensionality of the local descriptor by comparing the local descriptor to a tree-like clustering model and obtaining transformed data indicating the identity of the cluster. The transformed data is fed into an adaptive model which generates data indicative of the presence of drusen in the retinal image. Furthermore, the trans formed data can be used to obtain the location of the drusen within the image.

### FIELD OF THE INVENTION

The present invention relates to methods and systems for automatically detecting drusen lesions (“drusen”) within one or more retina photographs of the eye of a subject.

### BACKGROUND OF THE INVENTION

Age-related macular degeneration (AMD) is the leading cause of irreversible vision loss as people age in developed countries. In Singapore, it is the second most common cause of blindness after cataract. AMD is a degenerative condition of aging which affects the area of the eye involved with central vision. It is commonly divided into early and advanced stages depending on the clinical signs.

Early stages of AMD are characterized by accumulation of material (drusen) in the retina, and disturbance at the level of the retinal pigment epithelial layer, including atrophy, hyperpigmentation and hypopigmentation. These usually result in mild to moderate visual loss. Late stages of AMD are characterized by abnormal vessel growth which results in swelling and bleeding in the retina. Patients with late stages of AMD usually suffer rapid and severe loss of central vision within weeks to months. Structural damage from late stages of AMD reduces the ability of the patient to read fine detail, see people's faces and ultimately to function independently. The causes of AMD are multifactoral and include genetics, environmental, degenerative and inflammatory factors.

Because late stages of AMD are associated with significant visual loss and the treatment options are expensive, involve significant resources and have safety concerns, detection of the early stages of AMD is important, and may allow the development of screening and preventative strategies.

The socioeconomic benefits of primary and secondary prevention of AMD are enormous. The direct medical cost of AMD treatment was estimated at US$575 million in the USA in 2004. In addition, nursing home, home healthcare costs and productivity losses have not been included in this estimate.

It has been reported that the projected increase in cases of visual impairment and blindness from AMD by the year 2050 may be lowered by 17.6% if vitamin supplements are taken at early stages of the disease. At an approximate cost of US$100 per patient per year, supplementation with vitamins and minerals may be a cost-effective method of therapy for patients with AMD to reduce future impairment and disability. This is in contrast to the proposed treatment for late stages of AMD, which suggest at least 5-6 injections of ranibimubzub (US$1600/injection) in the first 12 months for sustainable visual gain. The direct medical cost of treating late stages of AMD is therefore very high. In fact several countries have issued guidelines limiting their use to selected patients who satisfy certain selected criteria set out after health economics review. This burden will undoubtedly increase as the population ages, straining the economic stability of health care systems. It is thus cost-effective to intervene at early stages of the disease. However at risk patients need to be effectively identified.

Currently, the treatment of late stages of AMD is extremely costly. Preventing early stages of AMD from progressing to late stages of AMD in middle age or early old age is likely to dramatically lower the number of people who will develop clinically significant late stages of AMD in their lifetimes. This is because having early stages of AMD increases the risk for advancing to late and visually significant stages of AMD by 12 to 20 fold over ten years.

However, since early stages of AMD are usually associated with mild symptoms, many patients are not aware until they have developed late stages of AMD. In addition, diagnosis of early stages of AMD currently requires examination by a trained ophthalmologist which is time and labour inefficient to allow screening at a population scale. A system that can analyse large numbers of retinal images with automated software to precisely identify early stages AMD and its progression will therefore be useful for screening.

### SUMMARY OF THE INVENTION

The present invention relates to new and useful methods and apparatus for detecting the condition of the eye from non-stereo retinal fundus photographs, and particularly a single such photograph.

In general terms the invention proposes automatically detecting and recognizing retinal images exhibiting drusen, that is tiny yellow or white accumulations of extracellular material that build up between Bruch's membrane and the retinal pigment epithelium of the eye. Drusen is a key indicator of AMD in non-stereo retinal fundus photographs.

The invention proposes dividing a region of interest in a single retina photograph including the macula centre into patches, obtaining a local descriptor of each of the patches, and detecting drusen automatically from the local descriptors.

This may be done by inputting data derived from the local descriptors into an adaptive model which generates data indicative of the presence of drusen.

The adaptive model may be trained to identify whether the retina photograph is indicative of the presence of drusen in the eye. Alternatively, it may be trained to identify locations within the eye associated with drusen.

Preferably, the local descriptors are transformed (e.g. prior to input to the adaptive model) into transformed data of lower dimensionality by matching the local descriptor to one of a number of predetermined clusters, and deriving the data as a label of the cluster. The clusters are preferably part of a tree-like cluster model.

Embodiments of the invention, however expressed, can be used as a potential tool for the population-based mass screening of early AMD in a fast, objective and less labour-intensive way. By detecting individuals with AMD early, better clinical intervention strategies can be designed to improve outcomes and save eyesight.

Preferred embodiments of the system comprise the following features:

1: The detection of the macula is performed by first determining the optic disc location, after which the eye from which the fundus image is obtained is determined. After knowing which eye the image is taken from, the macula is detected by using the optic disc centre as a point of reference and a search region for the macula is extracted. This search region includes all possible locations of the macula. The centre of the macula is located by a method based on particle tracking in a minimum mean shift approach. After the centre is located, a macula ROI is defined which is a region with a radius of two optic disc diameters around the macula centre.

2: Dense sampling is performed for the region characterisation by evenly sampling the points, which form a grid and the spatial correspondences between the points can be obtained. The local region characterisation is computed by descriptors which emphasise different image properties and which can be seen as a transformation of local regions.

3: The local region characterisation is represented by the structure known as the Hierarchical Word Image (HWI).

4: The statistics of the HWI are used to form the final representation of the ROI, from which a classifier model is trained and used for the detection of drusen in the identification of early stages of AMD.

The method may be expressed in terms of an automatic method of detecting drusen in an image, or as a computer system (such as a standard PC) programmed perform the method, or as a computer program product (e.g. a CD-ROM) carrying program instructions to perform the method. The term “automatic” is used here to mean without human involvement, except for initiating the method.

The data obtained by the method can be used to select subjects for further testing, such as by an ophthalmologist.

Alternatively, dietary supplements may be provided to subjects selected from a group of subjects to whose retina photographs the method has been applied, using the outputs of the method.

### BRIEF DESCRIPTION OF THE DRAWINGS

An embodiment of the invention will now be described for the sake of example only with reference to the following drawings, in which:

FIG. 1 is an flow diagram of the embodiment, additionally showing how an input retinal image is transformed at each step of the flow;

FIG. 2 is composed of FIG. 2(a) which shows an input image to the embodiment of FIG. 1, and FIG. 2(b) which shows vessels detected in the input image by a module of the system of FIG. 1;

FIG. 3 is composed of FIG. 3(a) which shows a FOV delineated by a white line superimposed on the an input image of FIG. 2(a), and FIG. 3(b) which shows a detected optic disc contour and macula search region;

FIG. 4 is composed of FIG. 4(a) which shows an initial location of seeds in a module of FIG. 1, FIGS. 4(b) and 4(c) which show the updated position of the seeds in successive times during the performance of a mean-shift tracking algorithm, and FIG. 4(d) which shows the converged location and in which the numbers indicate number of converged seeds;

FIG. 5 is composed of FIGS. 5(a), 5(b) and 5(c), which respectively show the process of macula ROI extraction of normal, soft drusen and confluent drusen, in which the square indicates the ROI having a dark spot in the centre representing the macula centre, and FIGS. 5(d), 5(e) and 5(f) are enlarged views of the respective ROI;

FIG. 6 illustrates a dense sampling strategy used in the embodiment;

FIG. 7 is composed of FIG. 7(a) which illustrates a Macula ROI in greyscale representation, and FIG. 7(b) which represents the same ROI in a HWI transformed representation (the “HWI channel”);

FIG. 8 shows four examples of HWI representations of the macula ROIs;

FIG. 9 illustrates the HWI interpretation of drusen; and

FIG. 10 illustrates a Drusen-related shape context feature used in one form of the embodiment.

### DETAILED DESCRIPTION OF THE EMBODIMENTS

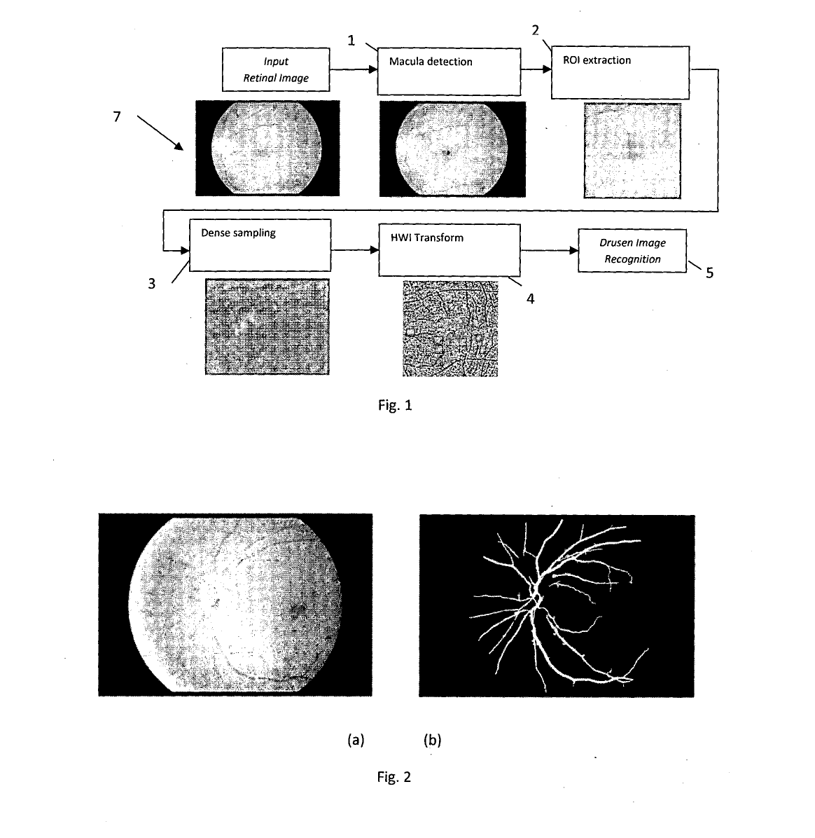

FIG. 1 illustrates the overall flow of the embodiment. The input to the method is a single non-stereo fundus image 7 of a person's eye.

The centre of the macula, which is the focus for AMD, is then detected (step 1). This involves finding a macula search region, and then detecting the macula within that search region.

The embodiment then extracts a region of interest (ROI) centered on this detected macula (step 2).

Next, a dense sampling approach is used to sample and generate a number of candidate regions (step 3).

These regions are transformed using a Hierarchical Word Image (HWI) Transform as described below, to generate an alternative representation of the ROI (step 4) from the local region signature.

Finally, characteristics from HWI are used in a support vector machine (SVM) approach to classify the input image (step 5). Optionally, step 5 may further include using the HWI features to localize drusen within the image.

There are several challenges to recognize drusen images. In general, drusen are small, have low contrast with their surroundings and can appear randomly in the macula ROI. Based on these characteristics, it would be more appropriate to represent a retinal image as a composite of local features. Further, as a single pixel lacks representative power, we propose to use a structured pixel to describe the statistics of a local context. That is, a signature will be assigned to a position based on the local context of its surroundings. The signatures at all the locations of the image form a new image, which we call a structured or hierarchical word image (HWI). In such an approach, we are able to adopt a top-down strategy which allows us to recognize and classify if an image has drusen or not without the need for accurate segmentation at an early stage.

1. Macula Detection (step 1)

The detection of the macula is an important task in AMD-related drusen analysis due to the characteristics of the disease pathology. Typically drusen analysis is limited to a region around the macula and this motivates the need for macula detection. Step 1 has the following sub-steps.

### 1. Retinal Image Field of View (FOV) Quality Analysis.

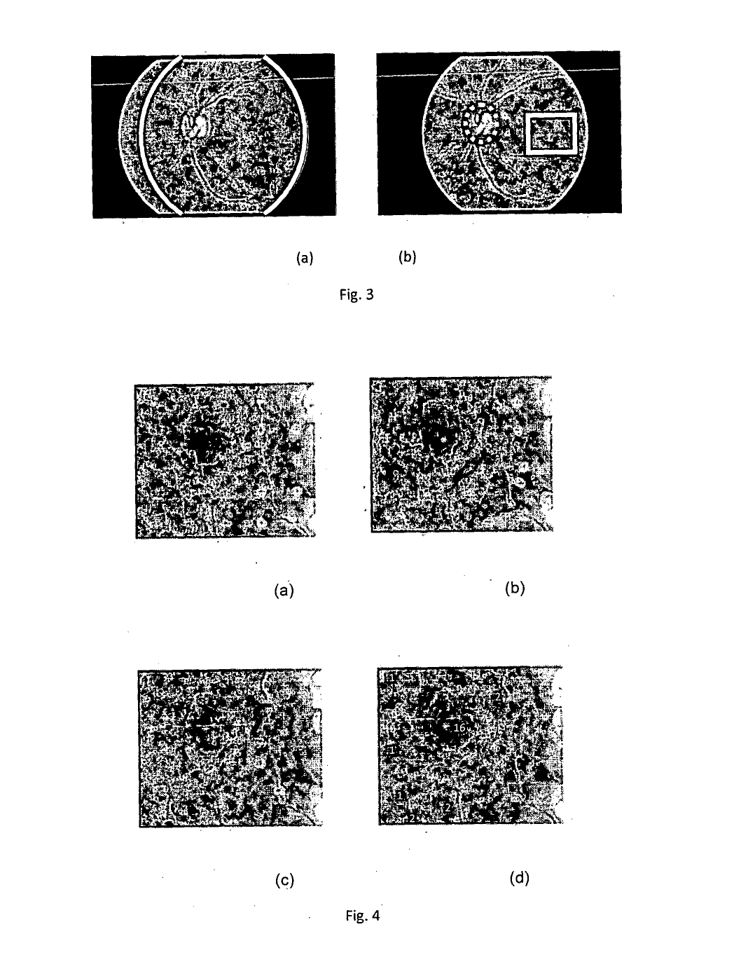

In some retinal fundus images (such as the one of FIG. 2(a)), a characteristic crescent caused by mis-alignment between the eye and the imaging equipment can be observed in the field of view. The artifact is usually of high intensity and its image properties can often be mistaken for other structures in the fundus image. To delimit the retinal image to exclude these halo effects, we use a measure based on vessel visibility. Regions of the image which are hazy are likely to also have low vessel visibility. A morphological bottom hat transform is performed to obtain the visible extent of vessels in the image (FIG. 2(b)). The size of the kernel element is specified to be equivalent to that of the largest vessel caliber. These visible vessel extents are used to define a new circular field of view mask to exclude non-useful and potentially misleading regions in the retinal image. This delimited FOV region is shown in FIG. 3(a) as the area between the bright arcs.

### 2. Optic Disk Detection.

The optic disc is one of the major landmarks in the retina. In our system, we obtain an estimate of the optic disk location and segmentation for use later. A local region around the optic disk is first extracted by converting the RGB (red-green-blue) image into grayscale, and selecting a threshold which corresponds to a top percentile of the grayscale intensity. In certain images, multiple candidate regions can be observed, and the most suitable region is automatically selected by imposing constraints. These constraints are based on our observations of the desired typical appearance such as eccentricity and size. Subsequently, the centre of the selected candidate region is used as a seed for a region growing technique applied in the red channel of this local region to obtain the optic disk segmentation. The detected optic disk is shown in FIG. 3(b) with the outline shown dashed.

### 3. Left/Right Side Determination.

In the next step, the eye from which the fundus image is obtained is determined. This information allows for the proper positioning of the ROI for the macula. Left/Right eye determination is carried out from a combination of factors using the previously detected optic disk, based on physiological characteristics and contextual understanding. For a typical retinal fundus image of a left eye, the optic disk has the following characteristics:

i. Intensity temporally>intensity nasally within the optic disk
ii. Optic disk vessels are located towards the temporal region
iii. Optic disk location is biased towards the left in Field 2 images (both macula and OD visible)

These properties are reversed for a right eye. Using the detected optic disk segmentation, the sum of the total grayscale intensity is calculated from pixels in the left and right sections of the optic disk. A bottom-hat transform is also performed within the optic disk to obtain a coarse vessel segmentation, and the detected vessels are aggregated in the left and right sections of the eye. Agreement from (i) and (ii) is used to determine the side of the eye, while (iii) is used as an arbiter in cases of disagreement.

### 4. Macula Detection.

The macula is a physiological structure in the retina, and the relationship of its location within the retina can be modeled with respect to other retinal structures. We use the optic disk as the main landmark for macula extraction due to the relatively well-defined association between the two structures. Using the optic disk centre as a point of reference and the side of the eye for orientation determination, a macular search region around the typical macula location is extracted. This macula search region derived from on a ground truth database of 650 manually labeled retinal fundus images. The centre of macula search region is based on the average (x,y) macula displacement from the optic disk centre, and the dimensions of the first ROI are designed include all possible locations of the macula, with an additional safety margin. The macula search region is shown in FIG. 3(d) as the light-coloured square.

The macula, which consists of light-absorbing photoreceptors, is much darker than the surrounding region. However, in the retina there can potentially be a number of macula-like regions of darker intensity. To effectively locate the centre of the macula, the embodiment uses a method based on particle tracking in a minimum mean shift approach. First, a morphological closing operation using a disk-shaped structuring element is used to remove any vessels within the macula search region. Next, an m×n grid of equally distributed seed points is defined on the macula search region, as shown in FIG. 4(a). In FIG. 4(a) the values of m×n used were 5×5, but in other embodiments m and n take any different values. An iterative procedure is then applied to move the seeds, as shown by the images of FIGS. 4(b)-(d). At every iteration, for each seed point, a local region is extracted around each point. The seed point moves to the location of minimum intensity in that local region. The process repeats for each seed point until convergence, or until a maximum number of iterations. At convergence, it can be expected that the m×n seeds have clustered at regions of local intensity representing potential macula candidates, as shown in FIG. 4(d) where the numerals indicated the number of seeds at each cluster. The N clusters with the highest number of converged seeds are identified as candidates, and are summarized by their centroid locations. Using the model derived from the ground truth data, a bivariate normal distribution is constructed and the location with highest probability is selected as the estimated position of the centre of the macula.

### 2. Macula ROI Extraction

Using the detected macula location, we proceed to extract a region of interest (ROI) based on the macula centre. There are two motivations for this step. The use of ROI in computer vision increases the efficacy of computation by localizing the processes applied to a targeted area instead of the entire image. Furthermore, following clinical grading protocol, AMD-related drusen grading is typically limited to 2 optic disk diameters around the macula centre. In the system, we make use this specification and extract a ROI which is equivalent to this specification for use in subsequent processing. In other embodiments the ROI may have a different shape, such as a circle, but using a square provides computational efficiency.

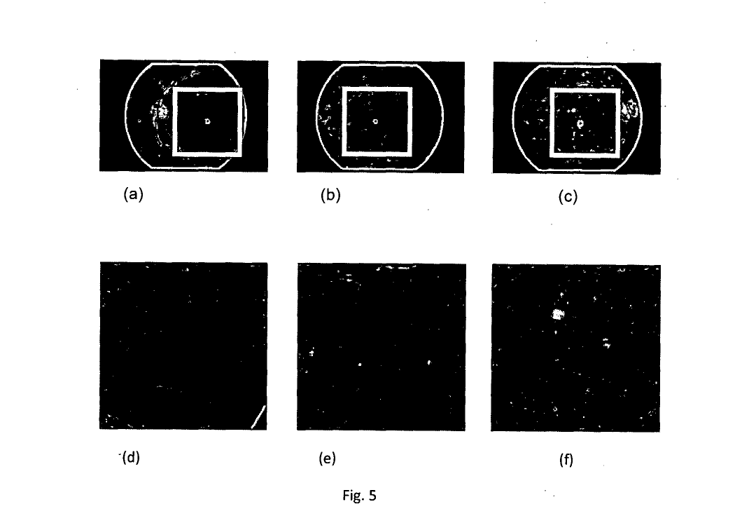

FIG. 5(a)-(c) are three examples of retina photographs with the respective ROIs shown in white, and FIG. 5(d)-(f) are the respective ROI shown in an enlarged view.

### 3. Dense Sampling for Region Characterization

### 1. Dense Sampling.

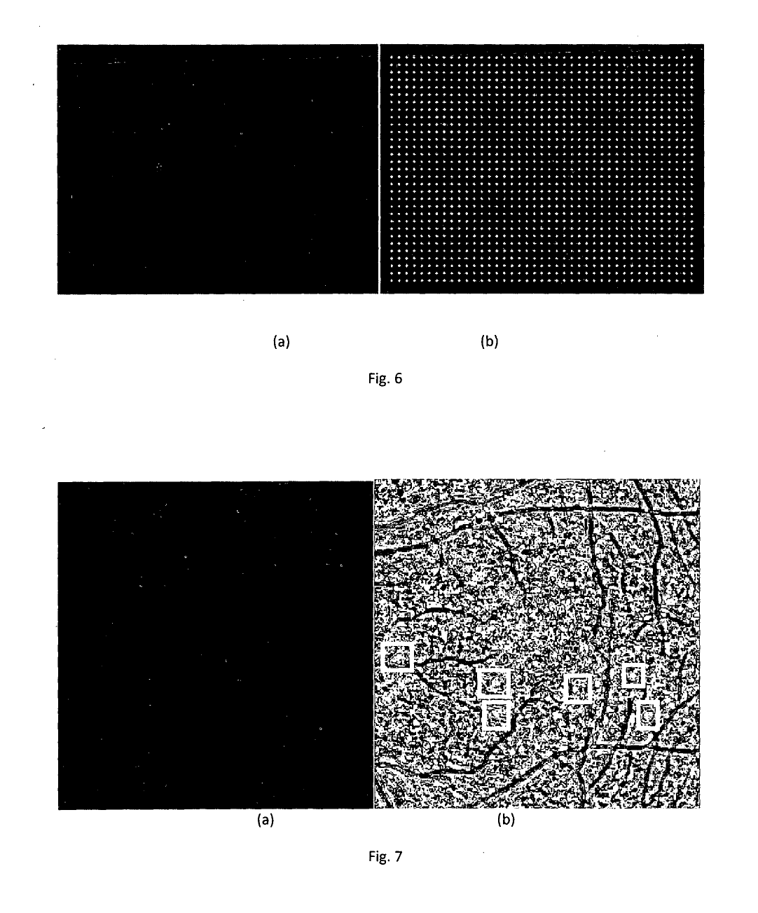

As a drusen region usually exhibits a small scale as well as low contrast with its surroundings, it is difficult to detect it well by detectors. Instead of using interest-point detectors, we adopt a dense sampled regular grid to extract sufficient regions for each image. To be exact, the ROI is divided into patches with a fixed size and displaced from neighbouring patches by a fixed step. The advantages of this sampling strategy are that (1) it can control the number, centers and scales of the patches, and (2) it can utilize the information of each image sufficiently because the patches cover the whole image. FIG. 6(a) shows an example of the ROI, and FIG. 6(b) shows the locations of the patches. The dots in FIG. 6(b) represent the centres of the respective patches, but in fact the patches collectively span the ROI. As the points are evenly sampled, they form a grid and the spatial correspondences between points can be easily obtained from that.

### 2. Local Region Characterization.

Descriptors computed for local regions have proven to be useful in applications such as object category recognition and classification. As a result, a number of descriptors are currently available which emphasize different image properties such as intensities, color, texture, edges and so on. In general, descriptors can be seen as a transformation of local regions. Given a local patch ┌, a descriptor [symbol] can be obtained by

[symbol]

= [symbol] (┌)

where [symbol] is a transformation function which covers certain properties of the input image patch. Compared with raw pixels of local regions, descriptors are distinctive, robust to occlusion, and can characterize local regions, so they can be regarded as local region signatures.

### 4. HWI (Hierarchical Word Image) Transformation

It is very complex and time-consuming to use the high-dimensional descriptors directly. The variation in cardinality and the lack of meaningful ordering of descriptors result in difficulty in finding an acceptable model to represent the whole image. To address the problems, clustering techniques are used in a “Bag-of-Words” method. To reduce the dimensionality, descriptors are usually grouped into clusters which are called visual words. Clustering aims to perform vector quantization (dimension reduction) to represent each descriptor with a visual word. Similar descriptors are assigned to the same visual word.

Usually, visual words are constructed from general clustering methods, such as K-means clustering method. However, clusters from these methods range without order and the similarity between different clusters is not considered. The embodiment employs a hierarchical k-means clustering method, which groups data simultaneously over a variety of scales and builds the semantic relations of different clusters. The hierarchical k-means algorithm organizes all the centers of clusters in a tree structure. It divides the data recursively into clusters. In each iteration (each node of the tree), k-means is utilized by dividing the data belonging to the node into k subsets. Then, each subset is divided again into k subsets using k-means. The recursion terminates when the data is divided into a single data point or a stop criterion is reached. One difference between k-means and hierarchical k-means is that k-means minimizes the total distortion between the data points and their assigned closest cluster centers, while hierarchical k-means minimizes the distortion only locally at each node and in general this does not guarantee a minimization of the total distortion.

To obtain a brief representation, we use only the leaf nodes to represent the hierarchical clustering tree and the upper level nodes can be computed by respective leaf nodes. Each descriptor [symbol] of an image patch is assigned to a certain leaf node ψ, which can be written as

ψ= [symbol] ( [symbol] )

Respectively, given a local patch ┌ at (x,y), we will obtain

$$ψ ( x , y ) = \text{(} \text{(Γ(} \text{x} \text{,} \text{y} \text{)))} {=}^{def} \text{(} \text{x} \text{,} \text{y} \text{)}$$

That is, each location corresponds to one leaf node. [symbol] can be see a transformation of the image. In this new channel, each pixel is a visual word based on the local context around it. We call the new channel as Hierarchical Word Image (HWI). FIG. 7(a) shows an example of a ROI, and FIG. 7(b) is a grey-scale version of a colour image which shows the HWI of the ROI, where different visual words are shown in different colours.

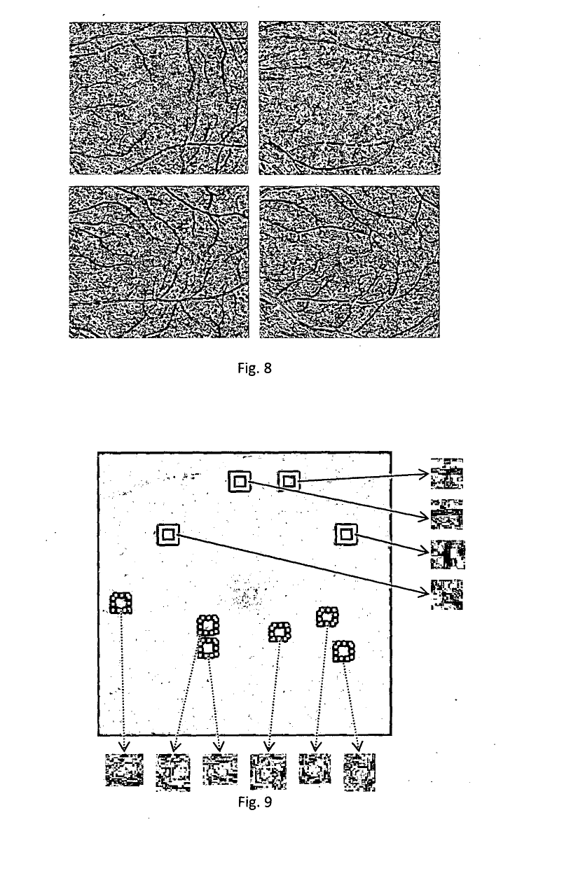

The new representation of HWI has many merits. First, the “pixel” in HWI encodes the local descriptor and refers to a specific structure of local patch. It is easy to describe an abstract object/pattern into a machine-recognizable feature representation. Second, compared to the descriptors obtained in step 3, HWI keeps the feature dimension low. The distribution of local patches in HWI can easily be computed and gives a more robust summarization of local structure. Third, compared to a general bag-of-words representation, not only the same visual words (clusters), but different visual words can be considered, which make partial matching efficient (i.e. the visual words of different clusters do not have to match exactly). FIG. 8 shows additional examples of the HWI representation for detected macula ROI.

### 5. Drusen Image Recognition

For the task of drusen image recognition, we adopt an algorithm similar to a Bag-of-words model. That is, we form a histogram of signatures from each structured image to represent the image.

For classification (i.e. deciding whether the image as a whole contains drusen in at least one location), we use a Support Vector Machine (SVM). The SWM is trained using a set of HWI-transformed training images (“training sample”) denoted by xᵢ where i is an integer labelling the training images. These images were used to perform the clustering. The HWI-transformed fundus image 7 (“test sample”) is denoted as x. The number of components in xᵢ and x depends upon the HWI transform. For each of the training images, we have a “class label” yᵢ which is +1 or −1 (i.e. this is a two-class example) according to whether the i-th training image exhibits drusen). For the two-class case, the decision function of the SVM has the following form:

$$g ( x ) = {\sum }_{i} {a}_{i} {y}_{i} K ( {x}_{i} , x ) - b$$

where K(xᵢ,x) is the value of a kernel function for the training sample xᵢ and the test sample x, αᵢ a learned weight of the training sample xᵢ, and b is a learned threshold parameter. The output is a decision of whether the image x exhibits drusen.

### Detection of Drusen.

Optionally, the HWI representation can also be used to provide a means for the detection and localization of drusen within the image. Since HWI encodes local descriptor and refers to a specific structure of a local patch, it is easy to separate different patterns in this channel, such as drusen regions and blood vessel regions. In the HWI channel, the drusen regions show up as six areas, which may be considered as lying on two concentric circles. The inside circle corresponds to visual words from one branch of the hierarchical tree and the outside ring corresponds to the visual words from another branch. FIG. 9 shows, as six dashed squares, where these drusen regions appear in the RGB version of the ROI (i.e. before the HWI transform). The four solid squares on the ROI in FIG. 9 mark areas containing vessels. FIG. 9 also shows (outside the borders of the ROI) the 10 portions of the HWI-transformed image corresponding respectively to these 10 squares in the ROI. For the blood vessels, there is an obvious threadlike region in the HWI channel, related to different visual words. We also observe that HWI boosts the characteristics of a structure. The weak structures (fuzzy drusens or slim blood vessels) become obvious in the HWI channel.

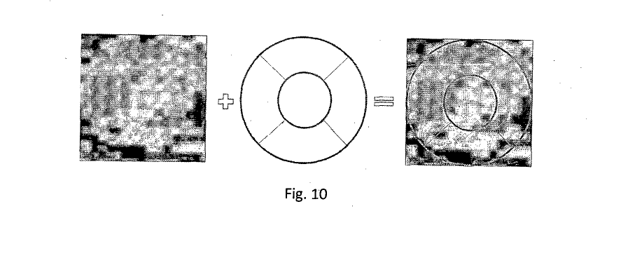

Thus, an optional additional part of step 5 is the location of drusen within the image, which may be done automatically in the following way. The left part of FIG. 10 shows the typical HWI transform of a patch associated with drusen, having a bright central region. Based on these characteristics, we propose a drusen-related shape context feature. To be exact, given a location, its contexture is divided into log-polar location grids, each spanning a respective grid region. As depicted in the central part of FIG. 10, the shape context feature used in the embodiment has five grids in the shape context: one in the centre, and the other four angularly spaced apart around the central one (in other embodiments, the number of these angularly spaced-apart grids may be different). Each grid is represented by a histogram from the HWI-transform of the local patch, and the embodiment represents the local patch by the concatenated vector of all the five grids. In order to perform drusen detection and localization, we first train an adaptive model using training manually labelled data of regions including drusen. In our experiments, a Support Vector Machine was adopted as the adaptive model, with either a linear or non-linear kernel. The detection window is scanned across the image at all positions and scales. Once the SVM is trained, the detection process is to scan the detection window across the HWI transformed image at all positions and scales, and for each position and scale use the shape context feature to obtain a concatenated vector from the 5 grids, and then input the concatenated vector into the trained SVM. This is a sliding window approach for drusen localization.

To speed up the detection, the Efficient Sub-window Search (ESS) can be used. The algorithm is disclosed at: “Efficient Subwindow Search: A Branch and Bound Framework for Object Localization”, by Lampert, Christoph H.; Max Planck Inst. for Biol. Cybern., Tubingen, Germany; Blaschko, M. B.; Hofmann, T., in Pattern Analysis and Machine Intelligence, IEEE Transactions on (Volume: 31, Issue: 12, p 2129.

1. An automatic method of analysing a retina image to detect the presence of drusen, the method comprising:
deriving a region of interest of the retina image including the macula;
dividing the region of interest into a plurality of patches,
obtaining a respective local descriptor of each of the patches, and
detecting drusen from the local descriptors by inputting data derived from the local descriptors into an adaptive model which generates data indicative of the presence of drusen.

2. The method according to claim 1 in which the local descriptors are used to generate respective transformed data of lower dimensionality by matching each local descriptor to a respective one of a number of predetermined clusters in a cluster model, and the data input to the adaptive model is obtained from the transformed data.

3. The method according to claim 2 in which the cluster model is a tree-like model having a branching structure including leaf nodes, the local descriptors being matched with leaf nodes of the branching structure, and the transformed data being in the form of data labelling leaf nodes by their position within the branching structure.

4. The method according to claim 1 in which the local descriptor comprises one or more of the following:
average intensity of the patch;
average colour of the patch;
texture of the patch; and
data characterizing edges within the patch.

5. The method according to claim 1 in which the adaptive model is adapted to produce an output indicative of the presence of drusen anywhere in the region of interest.

6. The method according to claim 1 in which the adaptive model is adapted to identify locations within the region of interest associated with drusen.

7. The method according to claim 6, in which the local descriptors are used to generate respective transformed data of lower dimensionality by matching each local descriptor to a respective one of a number of predetermined clusters in a cluster model, and the data input to the adaptive model is obtained from the transformed data, the method further comprising generating an transformed image from the transformed data, and for each of a plurality of locations in the transformed image, applying a context feature having a plurality of grid regions, to generate histogram data for each of the grid regions, the histogram data being input to the adaptive model.

8. The method according to claim 7 in which for each of the plurality of locations in the transformed image, the context feature is applied at a plurality of different distance scales, thereby at each distance scale generating respective histogram data to input into the adaptive model.

9. The method according to claim 7 in which the grid regions include a central grid region, and a plurality of additional grid regions surrounding the central grid region.

10. The method according to claim 1 in which the region of interest is derived by determining a position of the macula centre, and generating the region of interest as a region surrounding the macula centre.

11. The method according to claim 10 in which the operation of determining the position of the macula centre is performed by seeking a location of minimal intensity in a macula search region of the retina image.

12. The method according to claim 11 in which the location of minimal intensity is found by defining a plurality of seeds in the retina image, and iteratively moving the seeds to locations of minimal intensity in respective regions defined around the seeds.

13. The method according to claim 11 in which the macula search region is obtained by seeking the optic disk within the retina image, and defining the macula search region relative to the optic disk.

14. The method according to claim 13 further comprising determining whether the image relates to a left or right eye, and defining the macula search region relative to the optic disk accordingly.

15. A computer system for analysing a retina image to detect the presence of drusen, the computer system comprising a processor and a data storage device storing program instructions operative by the processor to cause the processor to analyse a retina image to detect the presence of drusen, by:
deriving a region of interest of the retina image including the macula;
dividing the region of interest into a plurality of patches,
obtaining a respective local descriptor of each of the patches, and
detecting drusen from the local descriptors by inputting data derived from the local descriptors into an adaptive model which generates data indicative of the presence of drusen.

16. A computer program product storing non-transitory program instructions operative by the processor to cause the processor to analyse a retina image to detect the presence of drusen, by:
deriving a region of interest of the retina image including the macula;
dividing the region of interest into a plurality of patches,
obtaining a respective local descriptor of each of the patches, and
detecting drusen from the local descriptors by inputting data derived from the local descriptors into an adaptive model which generates data indicative of the presence of drusen.
